(19) United States
(12) Patent Application Publication
(10) Pub. No.: US 2006/0223045 A1
(43) Pub. Date: Oct. 5, 2006

(54) System and method for capturing visual information of a device

(76) Inventor: Jason D. Lowe, Urbana, IL (US)

Correspondence Address: MOTOROLA INC, 600 NORTH US HIGHWAY 45, ROOM AS437, LIBERTYVILLE, IL, 60048-5343, US

(21) Appl. No.: 11/095,866

(22) Filed: Mar. 31, 2005

(51) Int. Cl. G09B 25/00

(52) U.S. Cl. 434/379

(57) ABSTRACT

A system (200) for capturing visual information of a device is provided. The system comprises a simulator (202), and a visual information module (204). The simulator is configured to generate a simulation of the operation of the device. The visual information module is configured to capture visual information of the device, based on the simulation. The visual information comprises at least one of, an image and a video of the device.

### FIELD OF THE INVENTION

The present invention relates generally to the field of simulation devices. In particular, the present invention relates to a system and method for capturing visual information of a device.

### BACKGROUND OF THE INVENTION

Product documentation typically includes an organized series of descriptive documents that explain the operation of a product, product's response to the user inputs, different stages in the operation of a product and the like. Product documentation, typically, includes images of the product. Currently, product documentation involves photographs being taken of a finished product, with a digital camera; or with the use of screenshots of a simulation to approximate the final product. Product documentation is useful in operation manuals, product marketing, education training, and so forth.

One concern with taking photographs of the finished product with a digital camera is that it is often not available for documentation until very late in the development cycle. This leaves little time to get the photographs and integrate them into the documentation before product release. In addition, quality digital cameras and lighting are required for superior quality photographs. Further, while taking photographs, someone has to properly frame the product in the camera viewfinder, ensure that the lighting is adequate, and the product is in an appropriate state, take the picture, and move the picture off the camera and into a form suitable for inclusion in the product documentation. This makes taking photographs an error prone and time intensive process. Moreover, the process has to be repeated for every photograph.

Similarly, rendering screenshots is a very labor-intensive, time consuming, and an expensive process. Screenshots rendered by artists are often not exact images of what appears on the screen of the display of the product. Further, artists generally use the finished product as a reference, which is usually made available to them quite late in the development cycle; or they work from concept drawings, which may not accurately reflect what the end product actually looks like.

Accordingly, there is a need for a mechanism that makes the simulation of the product available much earlier in the product cycle than the hardware of the product is made available. The mechanism should have scripting ability, so as to automatically obtain screen images. The mechanism should also eliminate optical, color and framing distortions/errors. The mechanism should capture the images in a digital format, so that they can be directly integrated into product documentation. Further, the mechanism should avail itself of a simulator, which can be easily and quickly transported to different locations.

### BRIEF DESCRIPTION OF THE DRAWINGS

FIG. 1 is an exemplary block diagram of a simulation system in accordance with the present invention.

FIG. 2 is a block diagram illustrating exemplary components of a system for capturing visual information of a device in accordance with the present invention.

FIG. 3 is a flow diagram illustrating an exemplary process of capturing visual information of a device in accordance with the present invention.

FIG. 4 is a flow diagram illustrating an exemplary process of preparing product documentation of a device in accordance with the present invention.

FIGS. 5 and 6 depict a flow diagram illustrating an exemplary process of preparing a video of the operation of a mobile phone handset in accordance with the present invention.

FIG. 7 is an exemplary simulator console window in accordance with the present invention.

FIG. 8 is an exemplary simulation window in accordance with the present invention.

FIG. 9 is a block diagram illustrating exemplary components of an electronic equipment in accordance with the present invention.

FIG. 10 is an exemplary script used by the simulator in accordance with the present invention.

### DETAILED DESCRIPTION OF THE PREFERRED EMBODIMENTS

The present invention relates to simulators for evaluating application or applications embedded in a device. For one embodiment, the device is a wireless communication device. Each application, embedded in the wireless communication device, is provided as input to the simulator, in the form of a data file. As the simulator operates, an output device displays an image of the wireless communication device that includes the housing, display, keypad, etc. Further, as the operation of the wireless communication device is simulated, the images of the input/output components of the simulated device change, particularly the display.

The present invention includes a visual capture function that records screen shots of simulated operation of a wireless communication device. The visual capture function captures visual information of the simulated device. The captured visual information may be used to generate a video of the operation of the device. The visual information may also be used to prepare operation manuals, product marketing, education training, and so forth.

One aspect of the present invention is a system for capturing visual information of a device comprising a simulator and a visual information module. The simulator is configured to generate a simulation of the operation of the device. The visual information module is configured to capture visual information of the device based on the simulation. The visual information comprises at least one of, an image and a video of the device.

Another aspect of the present invention is a method for capturing visual information of a device. A simulation of the operation of the device is generated using a simulator. The simulation is then used to record visual information of the simulated device.

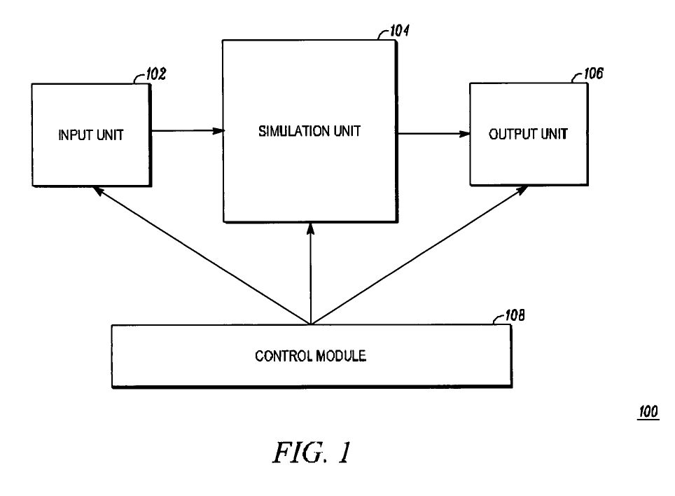

Referring to FIG. 1, there is shown an exemplary system for capturing visual information in accordance with the present invention. System 100 comprises an input unit 102, a simulation unit 104, an output unit 106, and a control unit 108. The input unit 102 is used to provide user inputs to the simulation unit 104. Examples of the input unit 102 include keyboards, joysticks, and the like. The simulation unit 104 generates a simulation of the operation of a device. For one embodiment, the device is a wireless communication device that utilizes a wireless protocol including, but not limited to, cellular-based communications such as analog communications (using AMPS), digital communications (using CDMA, TDMA, GSM, iDEN, GPRS, or EDGE), and next generation communications (using UMTS or WCDMA) and their variants; a peer-to-peer or ad hoc communications such as HomeRF, Bluetooth, IEEE 802.11 (a, b or g) and IEEE 802.16 (a, d, or e); and other forms of wireless communication such as infrared technology.

The simulation is generated, based on one or more application that is embedded in the device. The simulation unit 104 captures visual information of the device, based on the simulation. The visual information can be at least one of an image, a video, and an audio of the device. The visual information captured by the simulation unit 104 can be displayed on the output unit 106. Examples of the output unit 106 include a computer monitor, a television screen, or any other display device. The control unit 108 controls the operation of the input unit 102, the simulation unit 104 and the output unit 106.

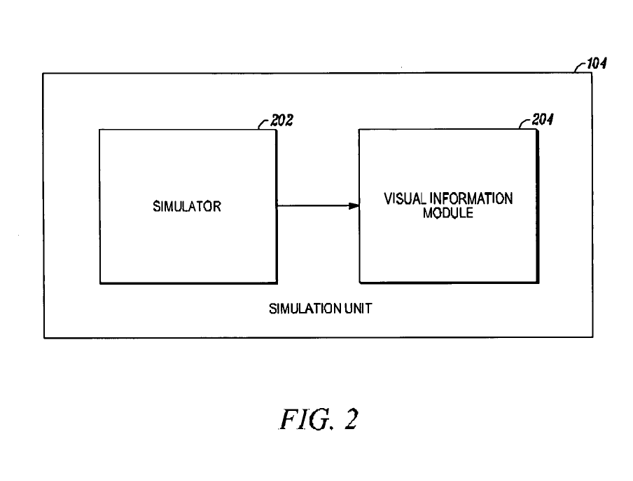

Referring to FIG. 2, there is shown a block diagram illustrating exemplary components of the simulation unit 104 for capturing visual information of a device, in accordance with the present invention. The simulation unit 104 includes a simulator 202 and a visual information module 204. For one embodiment, the simulator 202 is a application-program. For one embodiment, the input to the simulator 202 is the application that is embedded in the device, using which the simulator 202 generates a simulation of the operation of the device. The application embedded in the device is also known as operational application. The operational application may be in the form of a data file having an executable and linking format (ELF), a Motorola proprietary format (S Record), and/or a binary file format. For one embodiment, the simulator 202 runs the operational application in an application simulation that does not require the hardware of the device, and simulates operation of the data file's corresponding device. As the simulator 202 runs the operational application, the output unit 106 shows an image of the device that includes, the housing, display, keypad, etc. As the operation of the device is simulated, the input/output components of the device, particularly the display, change.

The visual information module 204 captures the visual information, of the operation of the wireless communication device, simulated by the simulator 202. The visual information can include screen shots of the simulated operation of the device, a video of the simulated operation of the device, and audio information. For one embodiment, the visual information can be captured at pre-defined time intervals. For another embodiment, the visual information is captured at pre-defined simulated events. For example, while simulating the operation of a mobile phone, the simulator 202 can be programmed to capture the screen of the mobile phone when a number is being dialed. In yet another embodiment of the invention, the visual information is captured based on at least one of, the rate of operation of the device and the rate of simulated operation of the device. The rate of the simulated operation of a device may be different from the rate of operation of the device. This has been further explained later in the detailed description section. The visual information of the device can be used to prepare product documentation of the device. The preparation of product documentation includes generating at least one of a video and an animation. The visual information can also be used to prepare a user manual, which includes product documentation of a device in online media format. Examples of online media format include a macromedia flash movie, an animated image, etc. A user manual may further include cues to draw the attention of a user to the input to be provided to the device. For example, if the ‘5’ key on the keypad of the device is pressed, it is highlighted in a different color, to draw the attention of the user to the input being provided. The user manual may also include cues to draw the attention of the user to output to be generated by the device. For example, if the call key is pressed after entering a phone number in a mobile phone, the screen can be highlighted to draw attention of the user to a change in the display.

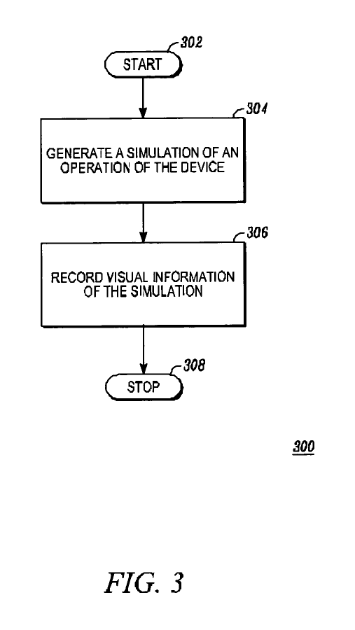

Referring to FIG. 3, a flow diagram illustrates an exemplary process of capturing visual information of a device, in accordance with the present invention. After initiating the process at step 302, the simulator 202 generates a simulation of the operation of the device, at step 304. The simulation is generated, based on the device's operational application that is provided as input to the simulator 202. Based on the simulation, the visual information of the device is recorded at step 306. For one embodiment, the visual information is recorded in an electronic format. Examples of electronic formats include JPG, GIF, JPEG, DAT, AVI, PNG, SWF, etc. Thereafter, the process terminates at step 308.

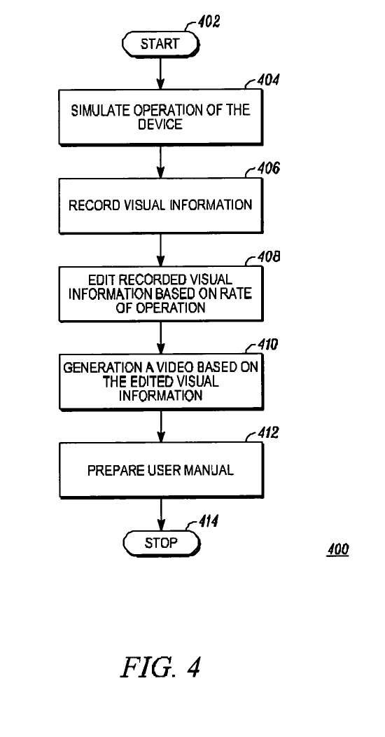

Referring to FIG. 4, a flow diagram illustrates an exemplary process of preparing product documentation of a device, in accordance with the present invention. After initiating the process at step 402, the operation of the device is simulated at step 404. The simulation is generated, based on the device's operational application, which is provided as an input to the simulator 202. Based on the simulation, the visual information of the device is recorded at step 406. The rate of the simulated operation of a device may be different from the rate of operation of the device. Therefore, the recorded visual information is edited based on the rate of operation of the device, at step 408. For one embodiment, the period between the capturing of two consecutive images is adjusted, to account for the difference in the rate of operation. For example, while simulating the operation of a mobile phone, if the simulator 202 takes longer to display an address book than the actual mobile phone, the visual capture function slows down the rate at which images are captured; so that when the final video is played, it is shown as operating at approximately the same speed as the actual mobile phone. Based on the visual information edited at step 408, a video is generated at step 410. For one embodiment, the simulator 202 can be programmed to capture 20 images per simulated second, which can be combined to generate a video. The video is used to prepare a user manual at step 412. Thereafter, the process terminates at step 414.

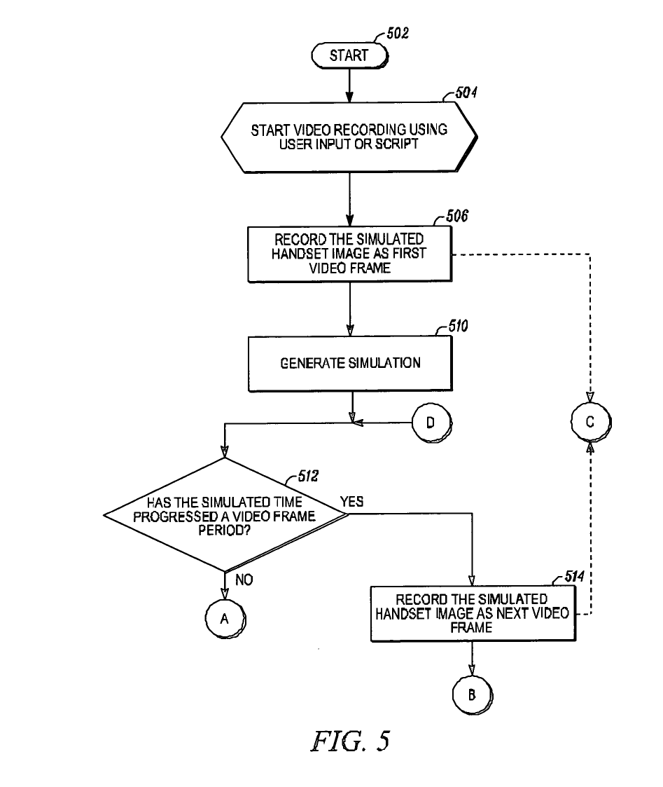

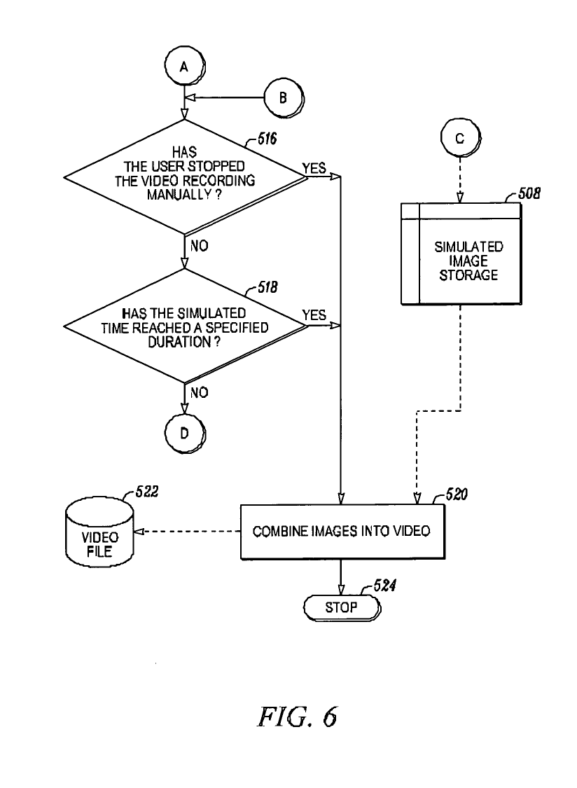

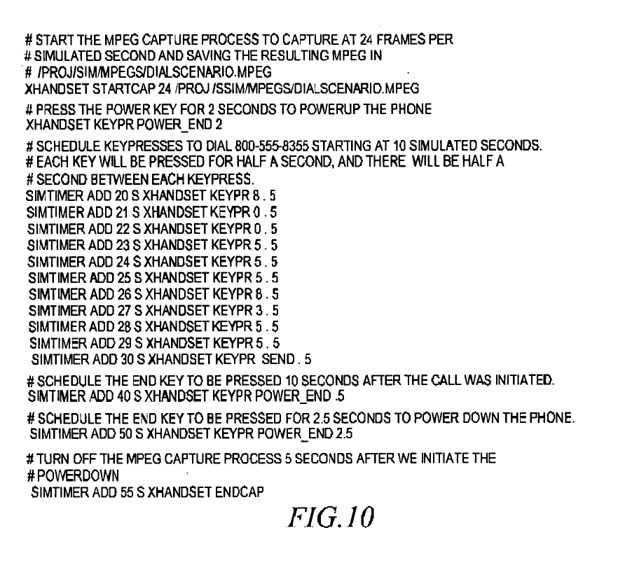

Referring to FIGS. 5 and 6, a flow diagram illustrates an exemplary process of preparing a video of the operation of a mobile phone handset, in accordance with the present invention. After initiating the process at step 502, a video recording is started, based on the user input or a script used for simulation, at step 504. An exemplary script used by the simulator 202 is shown in FIG. 10. Thereafter, a simulated handset image is recorded as the first video frame of the video recording, at step 506. For one embodiment, the simulated handset images are temporarily stored in a simulated image storage 508. The simulated image storage 508 is a random access memory (RAM). For one embodiment, the simulated handset images are stored in a magnetic storage device. Thereafter, the simulation is generated at step 510. At step 512, a check is carried out to verify whether the simulation time has progressed a video frame period. If the simulation time has progressed a video frame period, a simulated handset image, from the simulated image storage 508, is recorded as the next video frame, at step 514. After the simulated handset image is recorded at step 514, or if the simulation time has not progressed a video frame period at step 512, a check is carried out to verify whether the user has stopped the video recording manually, at step 516. If the user has not stopped the video recording, another check is carried out to verify whether the simulated time has reached a specified duration, at step 518. If the simulated time has not reached the specified duration, the steps 512 to 518 are repeated. If either the simulated time has reached the specified duration, or the user has stopped the video recording manually, the simulated handset images temporarily stored in the simulated image storage 508 are dynamically combined into a video, to generate a video file 522 at step 520. For one embodiment, the video file 522 is stored in a magnetic storage device. Thereafter, the process terminates at step 524.

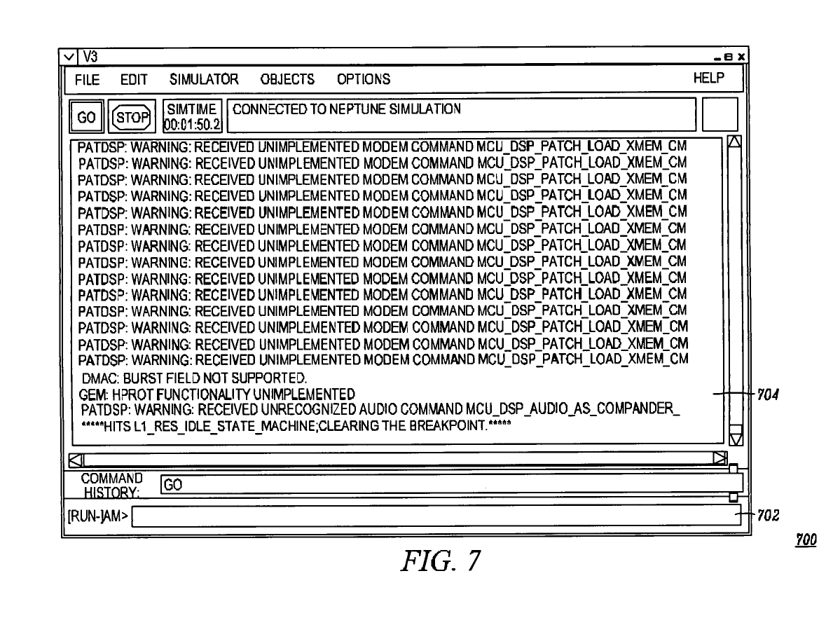

Referring to FIG. 7, an exemplary simulator console window 700, in accordance with the present invention, is shown. The simulator console window 700 is a user interface that can be used by the user to provide inputs to the simulator 202. In FIG. 7, a box 702 represents a space for providing user inputs. A region 704 represents the simulator 202's response to the user inputs, i.e., the state of the user inputs. Further, the region 704 also displays errors and warnings that may be generated by the simulator 202.

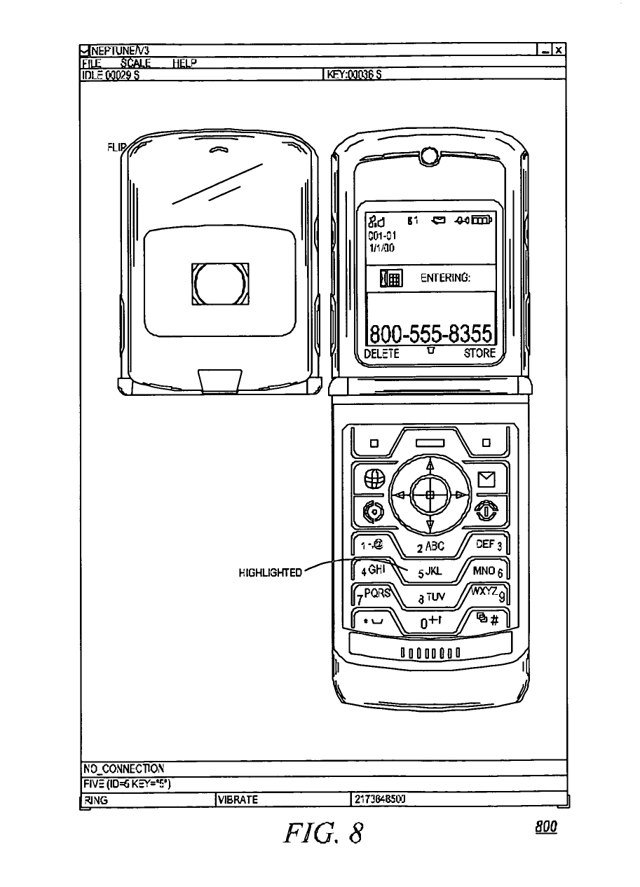

Referring to FIG. 8, an exemplary simulation window 800, in accordance with the present invention is shown. The simulation window 800 shows a simulated mobile phone image while a number is being entered. The screen of the simulated handset shows that a number, 800 555 8355, is being entered. The last digit entered is ‘5’, hence the ‘5’ key on the keypad is highlighted, i.e., a cue is rendered, to draw the user's attention to the input being given. Since the simulation is generated by using the operational application of the mobile phone, the simulated image, as shown in FIG. 8, is pixel-for-pixel identical to the mobile phone, which is the source of the image, i.e., visual information.

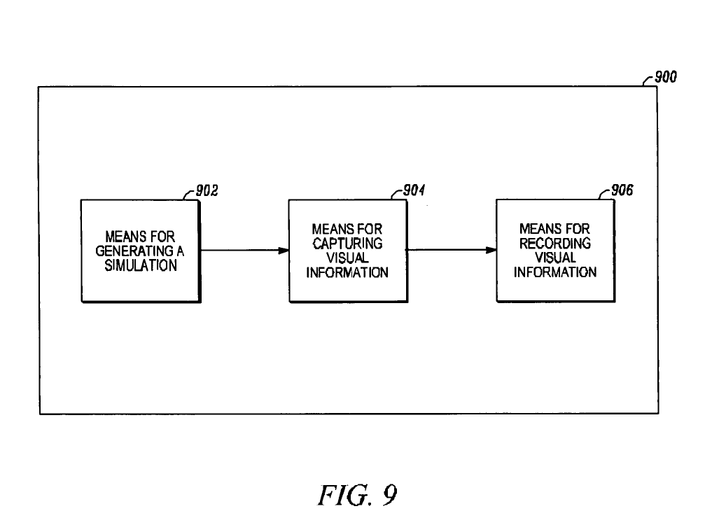

Referring to FIG. 9, a block diagram illustrates exemplary components of an electronic device 900, in accordance with the present invention. The electronic device 900 comprises a means for generating 902, a means for capturing 904, and a means for recording 906. The operational application of a device is provided as an input to the means for generating 902. Based on the operational application of the device, the means for generating 902 generates a simulation of the operation of the device. The means for capturing 904 captures visual information of the device, based on the simulation. For one embodiment, the visual information is captured automatically. For another embodiment of the invention, the means for capturing 904 captures visual information displayed in a subsection of the display device. The captured visual information is recorded by the means for recording 906, to generate at least one of a video, an animation, a user manual, and product documentation of the device. The captured visual information can also be used for evaluating the device.

FIG. 10 is an exemplary script used by the simulator 202, in accordance with the present invention. The script automatically records the switching on operation of a mobile phone, a phone call to 800-555-8355 for 20 seconds, and then the switching off operation of the mobile phone. The script programs the simulator 202, to capture simulated handset images at the rate of 24 frames per simulated second. Further, the script programs the simulator 202 to store the captured simulated images in a video file named as the ‘dialscenario.mpeg’ at the location /proj/sim/mpegs. The mobile phone is switched on by pressing a power key for two simulated seconds. Further, the power of the mobile phone is programmed to switch off 10 simulated seconds after the phone call was initiated.

It will be appreciated the system for capturing visual information described herein may be comprised of one or more conventional processors and unique stored program instructions that control the one or more processors to implement, in conjunction with certain non-processor circuits, some, most, or all of the functions of the system described herein. The non-processor circuits may include, but are not limited to, a radio receiver, a radio transmitter, signal drivers, clock circuits, power source circuits, and user input devices. As such, these functions may be interpreted as steps of a method to capture visual information. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein.

It is expected that one of ordinary skill, notwithstanding possibly significant effort and many design choices motivated by, for example, available time, current technology, and economic considerations, when guided by the concepts and principles disclosed herein will be readily capable of generating such application instructions and programs and ICs with minimal experimentation.

The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system. It is further understood that the use of relational terms, if any, such as first and second, top and bottom, and the like are used solely to distinguish one entity or action from another entity or action without necessarily requiring or implying any actual such relationship or order between such entities or actions.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A system for capturing visual information of a device, the system comprising:
a simulator configured to generate a simulation of operation of the device; and
a visual information module configured to capture visual information of the device based on the simulation, the visual information comprising at least one of an image and a video of the device.

2. The system of claim 1, further comprising a control module configured to control the capture of the visual information.

3. The system of claim 1, wherein the simulator simulates the operation of the device based on an application embedded in the device.

4. The system of claim 1, wherein the simulator is an application program configured to evaluate an application embedded in the device.

5. The system of claim 1, wherein the simulator simulates at least one of user inputs and expected system outputs.

6. The system of claim 1, wherein the visual information module captures audio information.

7. The system of claim 1, wherein the visual information further comprises at least one of an image, a video and an audio of the simulation of the operation of the device.

8. The system of claim 1, wherein the visual information is pixel-for-pixel identical to the source of the visual information.

9. The system of claim 1, wherein the visual information is captured automatically by the visual information module.

10. The system of claim 1, wherein the visual information is recorded in an electronic format.

11. The system of claim 1, further comprising an output unit comprising a display device configured to display the visual information of the device.

12. The system of claim 11, wherein the visual information module captures the visual information displayed in a subsection of the display device.

13. The system of claim 1, wherein the visual information is used for at least one of evaluation of the device, product documentation of the device, preparation of a user manual, and preparation of an animation of the operation of the device.

14. The system of claim 13, wherein the user manual comprises product documentation of the device in an online media format.

15. A method for capturing visual information of a device, the method comprising:
generating a simulation of an operation of the device; and
recording visual information of the simulation, the visual information comprising at least one of an image and a video of the device.

16. The method of claim 15, further comprising displaying the visual information on a display device.

17. The method of claim 15, further comprising at least one of evaluating the simulated device, preparing product documentation of the device, preparing a user manual, and preparing an animation of the simulation of the device.

18. The method of claim 15, further comprising recording audio information.

19. The method of claim 15, wherein generating the simulation of the operation of the device comprises executing an application embedded in the device.

20. The method of claim 15, wherein the visual information is captured automatically, the automatic capturing of the visual information comprising at least one of:
capturing visual information at pre-defined time intervals;
capturing visual information based on at least one of rate of operation of the device and rate of the simulated operation of the device; and
capturing visual information at pre-defined simulated events.

21. The method of claim 17, wherein preparing the product documentation comprises at least one of:
generating a video; and
generating an animation.

22. The method of claim 17, wherein preparing the user manual comprises at least one of:
rendering a cue to draw attention of a user to input to be provided to the device; and
rendering a cue to draw attention of the user to output to be generated by the device.

23. An electronic equipment for capturing visual information, the electronic equipment comprising:
means for generating a simulation of an operation of the device;
means for capturing visual information of the simulation, the visual information comprising at least one of an image and a video of the device; and
means for recording the visual information of the simulation.
